(19) United States
(12) Patent Application Publication
(10) Pub. No.: US 2012/0109852 A1
(43) Pub. Date: May 3, 2012

(54) REACTIVE LOAD BALANCING FOR DISTRIBUTED SYSTEMS

(75) Inventors: Sandeep Lingam, Bellevue, WA (US); Kanmin Zhang, Redmond, WA (US); Mark Benvenuto, Seattle, WA (US); David Lo, Saratoga, CA (US)

(73) Assignee: MICROSOFT CORPORATION, Redmond, WA (US)

(21) Appl. No.: 13/013,746

(22) Filed: Jan. 25, 2011

Related U.S. Application Data
(60) Provisional application No. 61/407,420, filed on Oct. 27, 2010.

(51) Int. Cl. G06F 15/16; G06F 17/00

(52) U.S. Cl. 705/400; 709/226

(57) ABSTRACT

The subject disclosure relates to load balancing systems and methods. In one embodiment, a reactive load balancer can receive feedback from a first database node, and allocate resources to the first database node based, at least, on the feedback. The feedback is dynamic and comprises information indicative of a load level at the first database node. In some embodiments, the feedback includes information indicative of a load level at a second, under loaded, database node. In other embodiments, load balancing is performed by an overloaded node polling a set of devices (e.g., cell phone, personal computer, PDA) at which resources may be available. Specifically, the method includes polling devices for resource availability at the devices, and receiving price information for resources provided by at least one device. The overloaded node utilizes the resource in response to providing payment of the price. Auction models or offer/counteroffer approaches can be employed.

### RELATED APPLICATION

This patent application claims priority to U.S. Provisional Application No. 61/407,420, filed Oct. 27, 2010 and entitled “REACTIVE LOAD BALANCING FOR DISTRIBUTED SYSTEMS,” the entirety of which is incorporated by reference.

### TECHNICAL FIELD

The subject disclosure relates to load balancing and, more specifically, to reactive load balancing in distributed systems.

### BACKGROUND

Conventional load balancing systems can implement various mechanisms in order to distribute load globally over a cluster of machines. These systems typically redistribute resources on a fixed schedule (e.g., once an hour) or by adding additional resources for overburdened machines. While these approaches may be satisfactory for addressing long-term load patterns, the long interval between analysis of the need for redistribution of resources inherently limits the effectiveness of the system when short-term load spikes occur. For example, if a central load balancer analyzes the need for redistribution of resources once an hour, a short-term load spike that persists for less than an hour can result in hot spots on a subset of machines in the cluster and cause unsatisfactory performance for the customers whose workloads are located on these machines.

In addition to operating on a fixed schedule, today, load balancers used in SQL AZURE® and similar technologies, typically attempt to perform a global optimization by spreading load uniformly throughout the entire cluster of machines. However, a drawback to this approach is that if load changes suddenly, then the cluster will be imbalanced until the next load balancer run. Accordingly, load balancers, today, do not adequately address balancing in clusters with highly-dynamic load changes.

Further, current reactive load balancers react to overloaded machines by simply sending requests to another machine. However, this form of load balancing requires user requests to be machine agnostic. In systems employing SQL AZURE®, however, this form of load balancing is inherently impossible because requests are tied to one specific machine. As such, for SQL AZURE® applications, the load balancer must physically re-allocate which machines can process what requests, which is not machine agnostic.

The above-described deficiencies of conventional load balancers are merely intended to provide an overview of some of the problems of conventional systems and techniques, and are not intended to be exhaustive. Other problems with conventional systems and techniques, and corresponding benefits of the various non-limiting embodiments described herein, may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In one or more embodiments, reactive load balancing is implemented. In one embodiment, a reactive load balancer can receive feedback from a first database node, and allocate resources to the first database node based, at least, on the feedback. The feedback is dynamic and comprises information indicative of a load level at the first database node. In some embodiments, the feedback includes information indicative of a load level at a second, under loaded, database node.

In other embodiments, load balancing is performed by an overloaded node polling a set of devices (e.g., cell phone, personal computer, PDA) at which resources may be available. Specifically, the method includes polling devices for resource availability at the devices, and receiving price information for resources provided by at least one device. The overloaded node utilizes the resource in response to providing payment of the price. Auction models or offer/counteroffer approaches can be employed.

In one or more embodiments, reactive load balancing is performed for a group of devices at a first granularity (e.g., once an hour). Then, a help signal indicating resource scarcity is received from one of the devices. The help signal is received at a second granularity (e.g., on a scale of minutes) that is substantially smaller than the first granularity. Reactive load balancing is then performed for the device from which the help signal is received. In some cases, reactive load balancing includes allocating resources from other devices to the device from which the help signal was received.

In one or more other embodiments, another reactive load balancing method includes receiving a help message from a node based on an overloaded state at the node. The node determines that it has an overloaded state prior to sending the help message. After receiving the help message, the reactive load balancer determines whether load balancing can be performed for the node. In the interim, additional help messages are squelched by the load balancer disallowing such additional messages for a pre-defined time period. For example, a negative acknowledgement (NACK) can be sent to the node to squelch any additional messages that would have been sent by the node. In this embodiment, no ACK messages are sent, yet flow control is performed through the use of repeat NACKs and/or repeat help messages as needed.

These and other embodiments are described in more detail below.

### BRIEF DESCRIPTION OF THE DRAWINGS

Various non-limiting embodiments are further described with reference to the accompanying drawings in which:

FIG. 1 is an illustrative overview of an exemplary system architecture for reactive load balancing in a distributed database system;

FIG. 2 is an illustrative overview of exemplary reactive help message processing;

FIGS. 3, 4, 5 and 6 are flowcharts illustrating exemplary non-limiting methods for facilitating reactive load balancing in accordance with embodiments described herein;

FIG. 7 is a block diagram illustrating states of a polling thread on a local database node;

FIG. 8 is a block diagram illustrating states of a reactive load balancing thread on a global load balancer;

FIG. 9 is a block diagram illustrating states of a database node in reactive load balancing state;

FIG. 10 is a block diagram representing exemplary non-limiting networked environments in which various embodiments described herein can be implemented; and

FIG. 11 is a block diagram representing an exemplary non-limiting computing system or operating environment in which one or more aspects of various embodiments described herein can be implemented.

### DETAILED DESCRIPTION

Certain illustrative embodiments are described herein in the following description and the annexed drawings. These embodiments are merely exemplary, non-limiting and non-exhaustive. As such, all modifications, alterations, and variations within the spirit of the embodiments is envisaged and intended to be covered herein.

As used in this application, the terms “component,” “component,” “system,” “interface,” and the like, are generally intended to refer to hardware and/or software or software in execution. For example, a component can be, but is not limited to being, a process running on a processor, a processor, an object, an executable, a thread of execution, a program and/or a computer. By way of illustration, both an application running on a controller and the controller can be a component. One or more components can reside within a process and/or thread of execution and a component can be localized on one computer and/or distributed between two or more computers. As another example, an interface can include input/output (I/O) components as well as associated processor, application and/or application programming interface (API) components, and can be as simple as a command line or as complex as an Integrated Development Environment (IDE). Also, these components can execute from various computer-readable media and/or computer-readable storage media having various data structures stored thereon.

### Reactive Load Balancing

While specific embodiments for reactive load balancing are described, the solutions described herein can be generalized to any distributed system wherein transactions are received for data and that define a workload. If the system is load balancing too granularly (e.g., every hour), the solutions described herein can supplement such load balancing to handle short-term spikes in load. As such, these embodiments can address the drawbacks of conventional load balancing, provide solutions that allow nodes to perform fast detection of a load spike, provide protocols to convey this information from individual nodes to a load balancer, and/or provide fast localized load balancing.

Reactive load balancing is described herein that reacts to excessive throttling on a node, and requests help from the global load balancer to relocate load away from the node. Reactive load balancing systems and methods described herein also are also resilient to failure, such as lost help or NACK messages or nodes becoming inoperable. As used herein, reactive load balancing means load balancing that reacts to help requests/messages/signals generated by a local database node.

As a roadmap for what follows next, various exemplary, non-limiting embodiments and features for reactive load balancing are described in more detail. Then, some non-limiting implementations and examples are given for additional illustration, followed by representative network and computing environments in which such embodiments and/or features can be implemented.

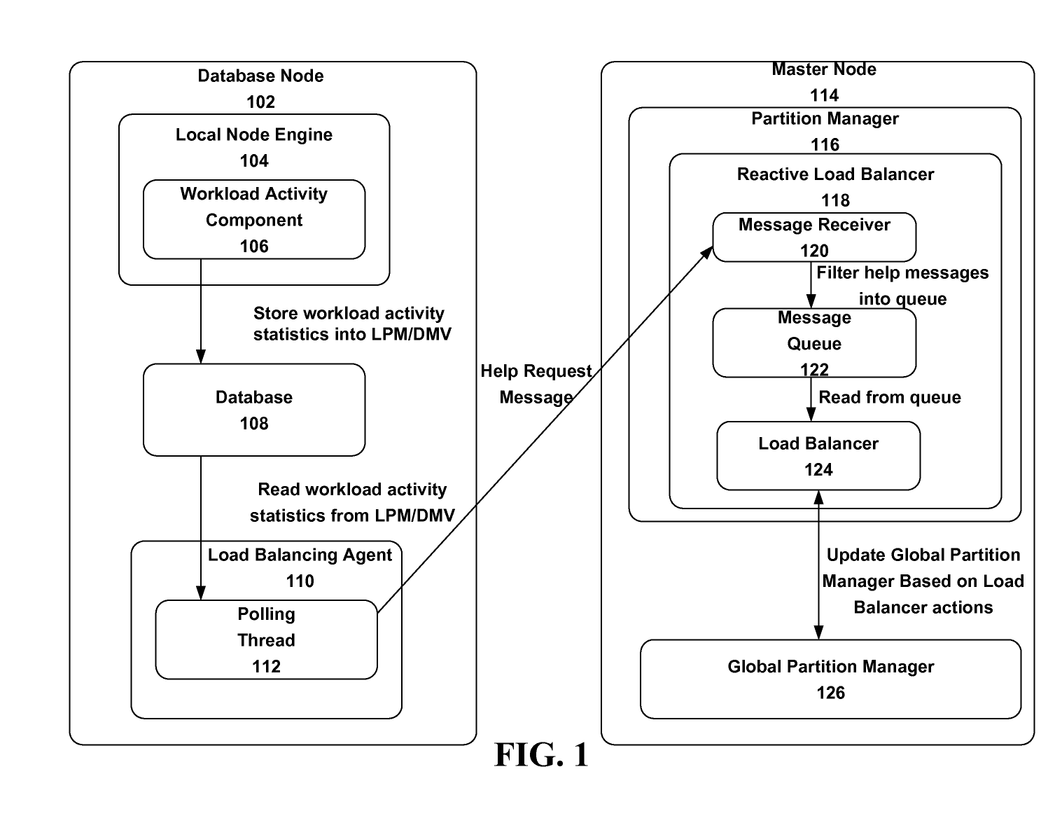

By way of description with respect to one or more non-limiting ways to conduct load balancing, an example load balancing system is considered, illustrated generally by FIG. 1, for balancing the workload of the database node (DN) 102. While a single master node (MN) 114 and a single DN 102 are shown in FIG. 1, it is understood that the DN 102 is part of a cluster of nodes, or machines, for which load balancing is performed. At any given time, the cluster of nodes or machines can be those that are alive in a particular network for which load balancing is performed.

The local node engine 104 of the DN 102 processes tasks associated with the DN 102. The workload activity component 106, also called an engine throttling component, monitors the workload activity level of the local node engine 104, and generates statistics indicative of the detected workload activity level. In some embodiments, the workload activity component 106 performs throttling (e.g., increasing speed of processing or suppressing user requests that cannot be handled, due to an overload of the limited resources at the DN 102). The rate, frequency or occurrence of throttling can correspond to the workload at the DN 102. Throttling may increase as the workload increases or increases beyond a predefined threshold.

The workload activity statistics are stored in the Local Partition Manager (LPM)/Dynamic Management View (DMV) of the database 108. In some embodiments, the workload activity statistics are statistics indicating the occurrence, rate and/or amount of throttling performed by the DN 102.

Two different protocols can be performed. In some cases, the load balancing agent (LB Agent) 110 for the DN 102 determines when excessive throttling is being performed by the DN 102, and then causes the DN 102 to signal the global Load Balancer (global LB) that the DN 102 needs help (in the form of resource allocation). The global LB can then attempt to perform a resource allocation, such as swapping a partition from an overloaded node to an under loaded node. This protocol utilizes local knowledge from the DN 102.

In other cases, DNs 102 request help from the global LB for the global LB to respond with a resource allocation. Load balancing decisions are then made for a centralized location due to the global knowledge afforded by a centralized system, which allows for more optimal decisions to be made.

Referring to the first protocol described above wherein local knowledge is utilized, the load balancing agent (LB Agent) 110 for the DN 102 reads workload activity statistics, or events inferred and stored in the database 108 based on the workload activity statistics.

When the workload activity statistics or events indicate that the DN 102 is becoming overloaded (or has become overloaded), a help message is generated and output from the DN 102. A polling thread can be employed 112 for performing such tasks.

The MN 114 can include a partition manager (PM) 116 that includes a reactive load balancer (reactive LB) 118. The reactive LB 118 may perform one or more of the load balancing tasks described herein.

For example, in one embodiment, the message receiver 120 of the reactive LB 118 receives the help message and filters the help message into a message queue 122. The LB 124 reads the help message from the message queue and performs the load balancing protocols for resource allocation. The LB 124 can update the global partition manager (GPM) 126 of the MN 114 with the re-allocated resource information.

In some embodiments, the MN 114 processes the help message, and performs decision making regarding resource allocation, on the order of seconds. As such, a fast message processing and decision making pipeline that employs fast polling intervals and “good enough optima” solutions are employed in some embodiments. Further, in some embodiments, the optimal waiting time to determine if a DN 102 is overloaded and/or the delays before the MN 114 is reactivated by a particular DN 102 to re-perform resource allocation can be activated again are tunable. For example, such factors are tuned to different values for different cluster configurations.

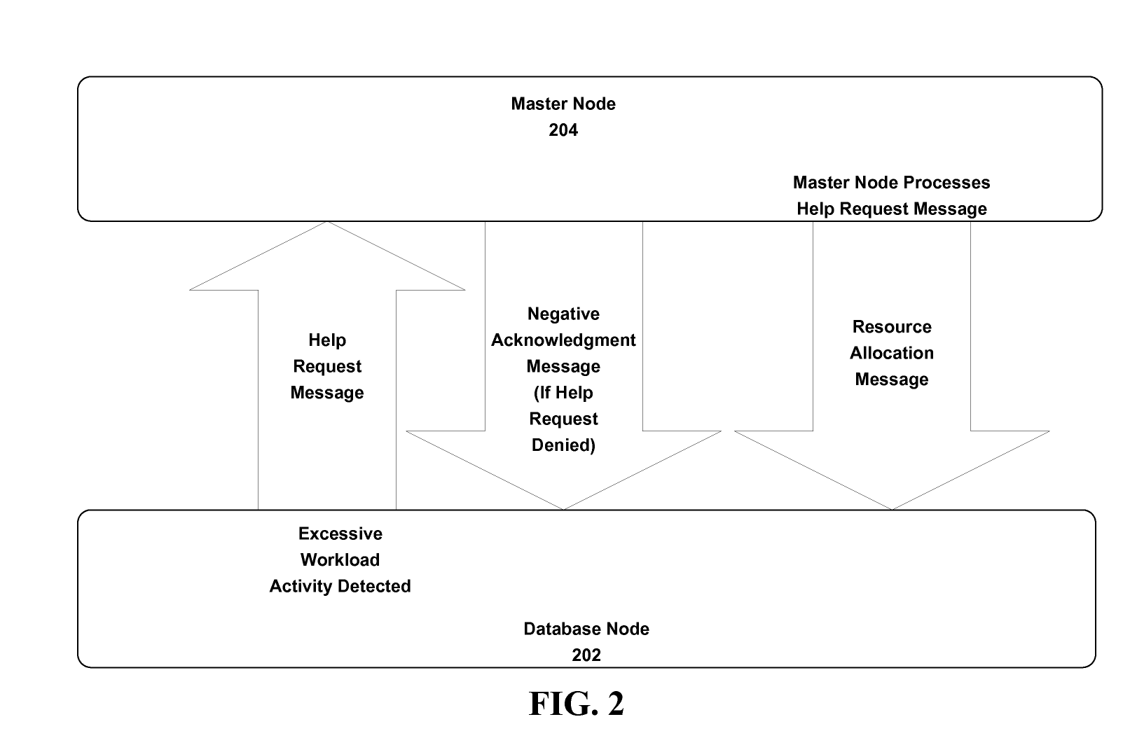

FIG. 2 is an illustrative overview of exemplary reactive help message processing. As described with reference to FIG. 1, the DN 202 detects excessive workload activity and transmits a help message to the MN 204. The MN 204 processes the help message and reallocates resources for the DN 202. In some embodiments, the LB (not shown) of the MN 204 determines that the LB is not equipped to handle the request from the DN 202. In these embodiments, the MN 204 can transmit a NACK to the DN 202 or simply fail to transmit a response to the DN 202.

Generally, when the DN 202 detects that it has become overloaded, it will then send a help message to the MN 204 via a protocol. The protocol contains facilities for the MN 204 to squelch the node from sending more help messages for a pre-defined time, in case the load balancer of the MN 204 is not available, the DN 202 was recently helped, or if no fix can be found for the DN 202. Once the MN 204 receives and accepts the help message, load balancing algorithms are performed in a localized fashion to determine if a solution can be found that balances load.

Individual machines (e.g., DN 102) in a cluster of machines report short-term spikes via the help message. The help messages are reported to the reactive LB 118. The reactive LB 118 analyzes a fraction of the load statistics typically provided in the conventional load balancing systems. For example, in typical systems, the reactive LB 118 analyzes cluster-wide data to solve short-term spikes efficiently. In some embodiments described herein, only time-sensitive local data is provided to global components to facilitate short term local optimization. New criteria to report such local data can be easily extended to fit specific cloud database implementations and load balancing goals.

Referring back to FIG. 1, the reactive LB 118 at the MN 114 may be defined to operate on a timescale smaller than that for conventional load balancers. For example, the reactive LB 118 can operate on a timescale of minutes as opposed to hours.

The following descriptions are specific to implementations wherein workload activity statistics or events are used by the MN 114 to determine a level of overload and/or whether a DN 102 is actually overloaded. In other embodiments, also envisaged herein, other mechanisms may be used to determine a level of overload and/or whether a DN 102 is overloaded. Further, in embodiments wherein reconfigurations and a PM 116 are used with global view to help reallocate load, other embodiments, also envisaged herein, may use other methods and component to subject disclosure relates to load balancing systems and methods. In to perform fast

To perform fast detection of overloaded nodes, the following method can be performed. An overloaded node, such as DN 102, determines whether it is overloaded and directly contacts the MN 114. This approach is in lieu of waiting for the central load balancer to receive statistics from other sources and determine if the DN 102 is overloaded. As such, unlike convention systems, there is no central agency that is relied upon to determine if a DN 102 is overloaded.

In some embodiments, whether DN 102 is overloaded may be defined in terms of whether DN 102 is experiencing performance degradation caused by the throttling resultant from the excessive workload. Performance degradation can be determined based on predefined resources including, but not limited to, central processing unit (CPU) utilization and disk latency, as some resources are machine independent (e.g., customer space usage), and these resources would not improve if moved to a different machine.

In some embodiments, an alternative to detecting excessive throttling to determine performance degradation is to create a new service/process that monitors whether excessive load is being applied by the node.

In some embodiments, windowed time-based sampling is used to determine if the DN 102 is overloaded. The use of windowed time-based sampling can reduce the problem of oscillating between overloaded and non-overloaded states caused by cases wherein throttling is invoked sparsely.

A network protocol can facilitate the load balancing as follows. The help message and NACK message are defined in the network protocol. The help message contains the latest statistics gathered from the DN 102 that is requesting help and ancillary data that can be used to inform the reactive LB 118 of what actions it should take.

The NACK message can be used for the reactive LB118 to tell a DN 102 to stop sending help messages for a short amount of time; in short, it is a flow control device.

Because overloaded nodes continually re-send help message messages unless explicitly squelched by receiving a NACK message, failure tolerance is built into the protocol and the protocol can forego the need to send ACK messages for resend capabilities. As such, if a help message is lost, the DN 102 continues to send new help messages as long as it remains overloaded and it has not received a NACK message. The reactive LB 118 re-sends another NACK message if the MN 114 receives another help message message from the DN 102. As such, the protocol maintains flow control operations notwithstanding a NACK may get lost.

In various embodiments, the NACK message can include the time span for which the NACK is effective. The NACK message can also include information indicative of the reason for sending the NACK message to the DN 102.

A failure model handles network messages that are lost between the DN 102 and the MN 114. In some embodiments, for messages sent from the DN 102 to the MN 114, the MN 114 does not explicitly send acknowledgements (ACKs) for received messages. Instead, only an explicit squelch message (e.g., a NACK message) from the MN 114 will be sent. The squelch message will disallow, or temporarily stop the DN 102, from sending additional messages upon receipt of the squelch message by the DN 102. A similar principle applies to messages sent from the MN 114 to the DN 102, as the DN 102 does not explicitly send ACKs for received messages. The only difference is that the DN node does not send squelch messages to the MN 114.

The different failure modes are as follows. If a help message sent from the DN to the MN is dropped prior to successful arrival at the MN, if the DN still needs help after an excessive throttling polling interval (during which the DN determines whether excessive throttling is continuing at the DN), the DN resends the help message to the MN.

If the NACK message is dropped prior to successful arrival at the DN, the next time the DN sends a help message that is received by the MN, the MN will resend the NACK with the appropriate NACK timeout interval.

If the MN fails to operate properly, the in-memory queue of pending help messages will be lost. However, because the associated DNs have not received a NACK, the DNs will resend their help messages at the next run of the excessive throttling polling thread and the in-memory queue will be rebuilt.

If the DN fails to operate properly, the DN loses its local state that keeps record of engine throttling and its quiescence status. The engine throttling history will be rebuilt with time, and if the DN starts emitting help messages when the DN is disallowed from emitting the help messages, the MN will send a NACK to the DN and inform the DN how long sending help messages is disallowed.

Using the protocol described, flow control in the load balancer algorithm is performed. If a node cannot be helped, which may happen if the cluster is performing a more critical task, if the node was already helped recently, or if the node had requested help before and no solution could be found, then the node will be marked as squelched. If that node asks for help again, then a NACK message will be sent back using the protocol described above. When the squelch time has expired, then help messages will be allowed again.

The approaches for localized load balancing are distinguished from conventional approaches which run an entire load balancing suite while requiring that the load balancer has the latest view of the entire cluster (and therefore are computationally expensive and can generate inappropriate actions), and/or which attempt to balance the entire cluster instead of merely responding to the needs of overloaded nodes in a cluster of nodes. By contrast, the embodiments described herein do not need an updated view of the entire cluster of nodes in order to perform localized load balancing for only the overloaded node from which the help message has been received and processed.

In some embodiments, load balancing is achieved by co-opting the existing load balancing algorithms that are restricted to only shift load away from nodes that requested help using the previously described protocol and to only perform a certain subset of operations that complete in a short amount of time. As such, operations such as moving databases are not performed as these operations are time-consuming.

In one embodiment, each piece of user data is stored on a number of machines (e.g., 3 machines). The number of machines can be limited to a small number such as 3 or 4 to perform the resource allocation quickly. As such, for each database node, there are two other candidate machines that the reactive LB 118 can analyze to determine whether the candidate can be provided for a swap for the overloaded DN 102. When a candidate is identified, user processing is temporarily stopped at the DN 102 and user processing is then re-routed to the new machine. As a further example, if one machine is having trouble, if there are 100 customers, there are 200 candidate choices (employing the model above for which there are two candidates for which a swap can take place).

The reactive load balancer 118 can perform the load balancing based on past information. For example, in some embodiments, the reactive load balancer 118 can perform the load balancing based on information from the previous 30 minutes.

While not shown in FIGS. 1 and 2, in some embodiments, the reactive LB 118 can receive messages from under loaded nodes informing the reactive LB 118 that the under loaded node has resources that are available for use by overloaded nodes (and/or that the under loaded node is not available and/or that the under loaded node is no longer available). As such, the embodiments described herein can be further enhanced by reducing the number of nodes that the reactive LB 118 considers for reallocation of resources because the reactive LB 118 can consider the under loaded nodes from which the reactive LB 118 has received an appropriate message in a past designated amount of time.

While the embodiments of FIGS. 1 and 2 are discussed in the context of a central, reactive LB 118 of the MN 114, in some embodiments, multiple nodes (not shown) can facilitate load balancing in a distributed fashion. In this embodiment, de-centralized load balancing is performed. For example, devices in a network may perform peer-to-peer sharing of resources. The devices can be any devices having processing capability that may be utilized by the node, including but not limited to, a cell phone, personal computer (PC), laptop, personal digital assistants (PDAs), laptops, etc.

Specifically, a node that has detected that its workload activity level is excessive polls one or more devices in a network to which the node is associated. Devices polled that have resources usable by the node can offer the resources to the node at a price set according to a billing model. The price can be based on an amount of resource used, a type of processing being performed, a time that the resource is used or the like. The billing model can include the node making a counteroffer to the offer made by the device for a lower price, negotiation of terms of use, and/or an auction model whereby the device auctions resources to one or more nodes that request help by taking bids from the nodes and providing the resource to the highest bidder.

Additionally, though the majority of the above-described systems and techniques are provided in the context of distributed database systems, embodiments described herein are applicable to any system wherein resource utilization varies and dynamic resource allocation is possible. For example, an embodiment envisioned and included within the scope of this disclosure is a system that has multiple virtual machines (VMs). If the resource allocation is dynamic instead of static, individual VMs could send help messages to a host as the VMs are nearing or reaching capacity and the host can implement the protocols described herein to determine if alternate resources are available, and perform allocation of such alternative resources.

In a related embodiment, load balancing can be performed on a cloud platform, such as WINDOWS AZURE, or similar platform if many different applications share a single VM (instead of a single VM—single application model). If the VM becomes overloaded, the application can provide a request for additional resources, and be re-instated on another VM.

As yet another embodiment, when resources are oversubscribed/overbooked, the load balancing described herein can be used. Specifically, when a customer requests the Quality of Service (QoS) promised, and the resources have been overbooked, the load balancing can be performed to reallocate resources and meet the QoS needs of the customer with fast reactivity.

As yet another example, the protocol can be used in any distributed environments, including environments distributing SQL cache usage, or other similar environments. In various embodiments, the protocol for reactive load balancing can be built on top of memory cache systems generally.

In various embodiments, the embodiments described herein can be utilized for systems employing SQL® servers, SQL AZURE® platforms, XSTOR™ frameworks and the like.

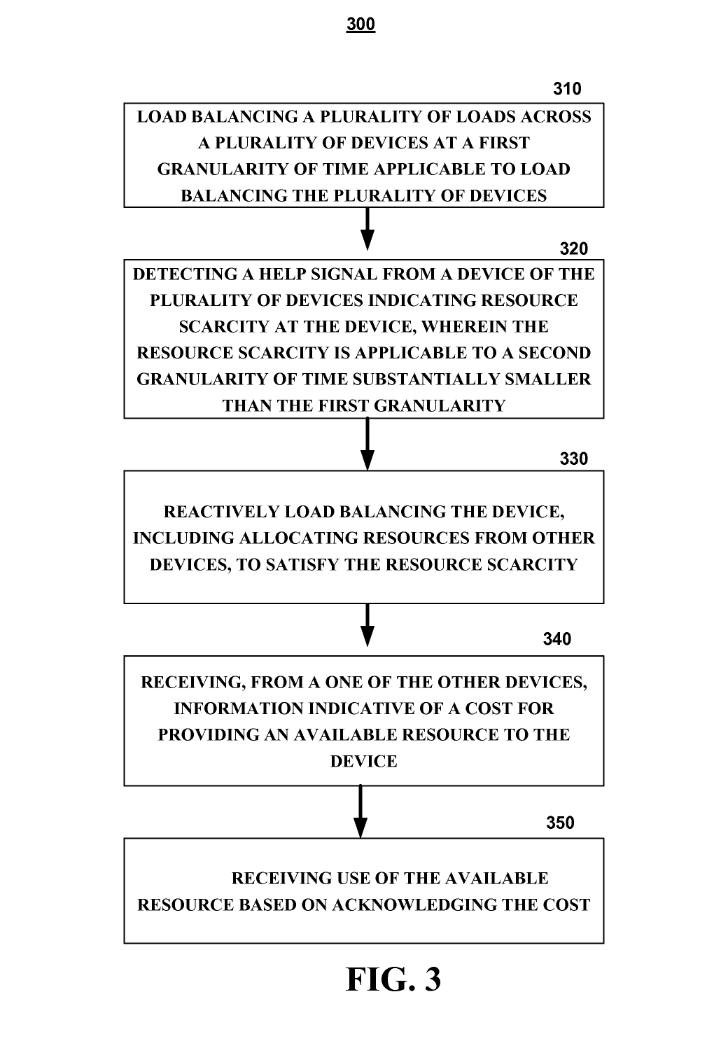

FIG. 3 is a flowchart illustrating an exemplary non-limiting method for facilitating reactive load balancing in accordance with embodiments described herein. At 310, method 300 includes load balancing a plurality of loads across a plurality of devices at a first granularity of time applicable to load balancing the plurality of devices. At 320, method 300 includes detecting a help signal from a device of a subset of the plurality of devices indicating resource scarcity at the subset of the plurality of devices applicable to a second granularity of time substantially smaller than the first granularity.

At 330, method 300 includes reactively load balancing the subset of the plurality of devices including allocating resources from devices other than the subset of the plurality of devices to satisfy the resource scarcity.

At 340, method 300 includes receiving, from a device of the devices other than the subset of the plurality of devices, information indicative of a cost for providing an available resource of the device. In some embodiments, the information is based on an auction model. In some embodiments, the information is based on a counteroffer from a device polling the plurality of devices.

At 350, method 300 includes receiving use of the available resource based on acknowledging the cost. In some embodiments, receiving use of the available resource includes receiving use based on paying a price for the cost for providing the available resource.

Another embodiment of facilitating reactive load balancing is as follows. When a node detects that it has become overloaded, the node sends a help message to the central load balancer via a protocol that contains facilities for the central agent of the central load balancer to squelch the node from sending more help messages for a designated time. Squelching the node is useful in cases wherein the load balancer isn't available, the node was just recently helped and/or no fix can be found.

Once the central agent receives and accepts the help message, the central agent runs load balancing algorithms in a localized fashion (as opposed to a centralized fashion) to determine if a solution can be found that balances load off of the node that requested help and applies any fixes found. In some embodiments, the centralized fashion of load balancing includes load balancing while requiring that the load balancer has the latest view of the entire cluster. Such an approach can be computationally expensive and can generate inappropriate actions. For instance, certain load balancing operations, such as moves, do not complete in an acceptably short amount of time. Furthermore, the intent of reactive load balancing is to respond to nodes that are overloaded, whereas the existing load balancing algorithms, that perform centralized load balancing, attempt to balance the entire cluster.

In some embodiments, flow control can be performed in the load balancer algorithm. If a node cannot be helped, which may happen if the cluster is performing a more critical task, if the node was already helped recently, or if the node had requested help before and no solution could be found, then the node will be marked as squelched. If that node asks for help again, then a NACK message will be sent back using the NACK/help message protocol described. When the squelch time has expired, then help messages will be allowed again. In some of these cases, although not all, the above protocol for flow control can be performed if global knowledge of the cluster is known.

Instead of waiting for statistics to be sent to the central load balancer and then having the central load balancer determine if a node is overloaded, in embodiments described herein, the node that sent the help message is capable of determining if the node is experiencing excessive load. In some embodiments, the node determines that it is overloaded if the node is experiencing performance degradation. Performance degradation can be caused by throttling of the engine of the node. For example, the engine of the node is configured to throttle back user requests that the machine associated with the node cannot handle due to limited resources. The process of throttling back requests is faster than methods that require a central agency to determine if the node is overloaded. In lieu of such an approach, the node itself determines whether it is overloaded by detecting the activity (e.g., throttling) of the node, and throttling back requests in response to such detection.

In some embodiments, a windowed time-based sampling is employed to determine if the node is actually overloaded. The windowed time-based sampling is employed during the period of time that the node has determined that the node is overloaded. Windowed time-sampling is employed to avoid rapidly flapping between overloaded and non-overloaded states caused by cases where throttling of the engine of the node is invoked sparsely.

Performance degradation can be determined based on predefined resources including, but not limited to, central processing unit (CPU) utilization and disk latency, as some resources are machine independent (e.g., customer space usage), and these resources would not improve if moved to a different machine.

The above-referenced NACK/help message protocol is as follows. A help message and a NACK message are employed during the protocol. The help message contains the latest statistics gathered from the node that is requesting help. In some embodiments, ancillary data is also included and can be used to inform the load balancer of what actions the load balancer should take.

The NACK message is sent from the load balancer and is a message that enables the load balancer to inform the node to stop sending help messages for a pre-defined amount of time. As such, the NACK message is employed as a form of flow control to control the help message traffic from the node requesting help. The NACK message is sent to the node whenever the central load balancer receives a help message from a node from which the central load balancer is not expecting to receive any additional help messages.

Failure tolerance arises in this protocol by having overloaded nodes continuously send help messages unless they are explicitly squelched by a NACK message from the node. This failure tolerance allows the protocol to forego ACK messages for resend capabilities, as the protocol already resends help messages. If a help message is lost, the node will continue sending new help messages as long as the node remains overloaded and the node does not receive a NACK message. If a NACK message is lost (and therefore not received by the node), the central load balancer will simply resend another NACK message if the node continues sending the central load balancer help messages, as seen in FIG. 2.

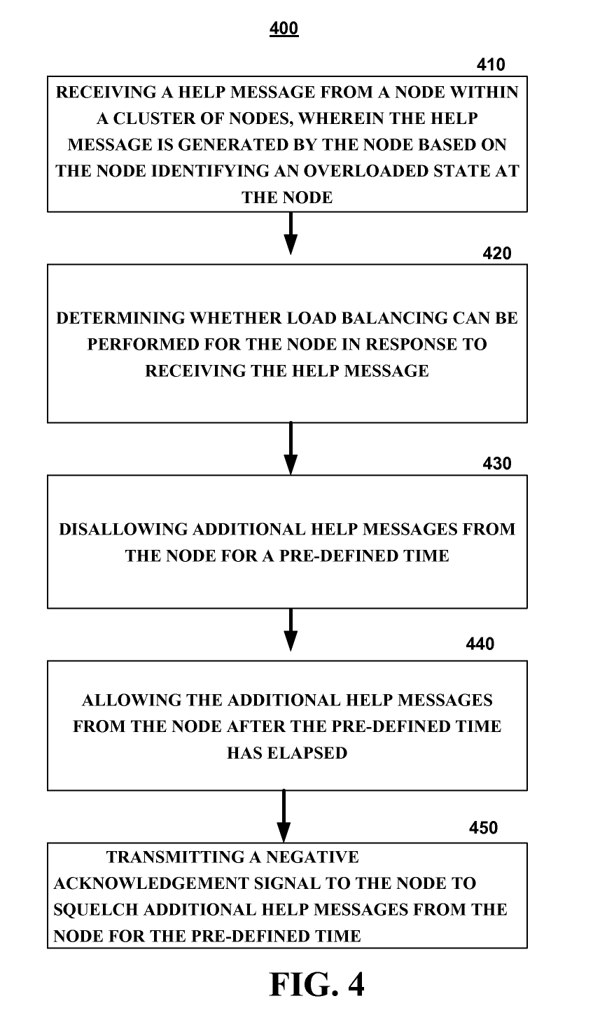

FIGS. 4, 5 and 6 are flowcharts illustrating exemplary non-limiting methods for facilitating reactive load balancing in accordance with embodiments described herein.

Turning first to FIG. 4, at 410, method 400 includes receiving a help message from a node within a cluster of nodes. The help message is generated by the node based on the node identifying an overloaded state at the node. The help message includes statistics gathered by the node and, in some cases, also includes information indicating action desired by the node.

At 420, method 400 includes determining whether load balancing can be performed for the node in response to receiving the help message.

At 430, method 400 includes disallowing additional help messages from the node for a pre-defined time. In some embodiments, the pre-defined time is 300 seconds, although any number of suitable seconds can be employed. Disallowing can be employed in response to determining that either load balancing cannot be performed for the node, load balancing was performed for the node during a first pre-defined past time interval, load balancing was attempted for the node during a second pre-defined past time interval and no load balancing could be performed or the help message has been received and processing has not been completed.

At 440, method 400 includes allowing the additional help messages from the node after the pre-defined time has elapsed. At 450, method 400 includes transmitting a negative acknowledgement signal to the node to squelch disallowed additional help messages from the node for the pre-defined time.

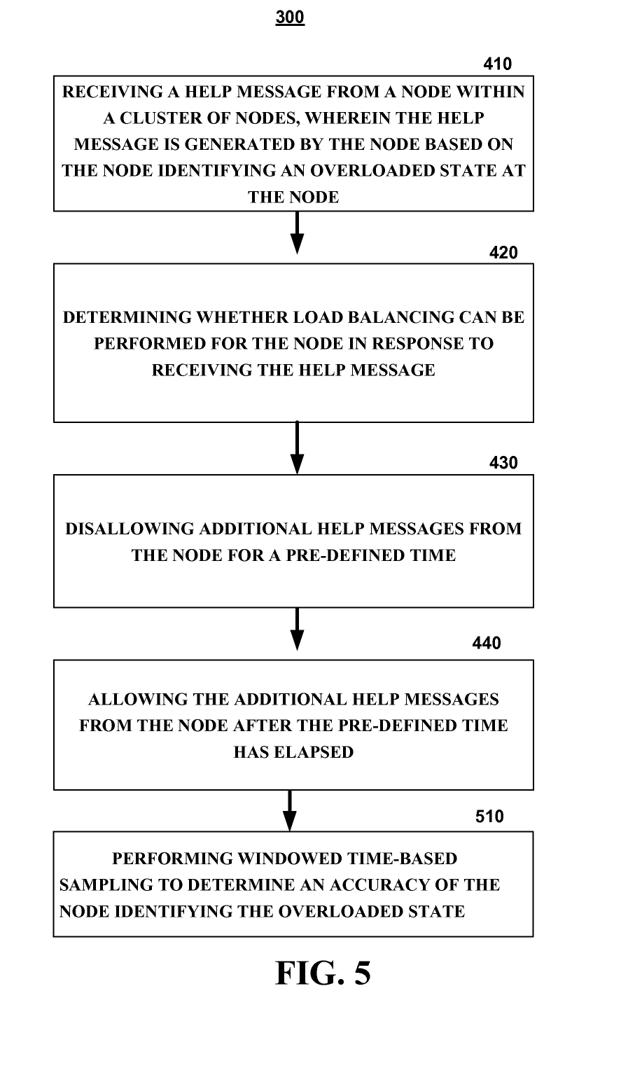

Turning now to FIG. 5, method 500 includes 410-440 of method 400 as described above. At 510, method 500 includes performing windowed time-based sampling to determine whether the node has accurately identified itself as having an overloaded state. In some cases, windowed time-based sampling is performed during the time interval that the node identifies the overloaded state based on performance degradation that is identified at the node by the node. Performance degradation is identified in a number of different ways including, but not limited, identifying that the node is throttling back requests received at the node due to limited resources at the node.

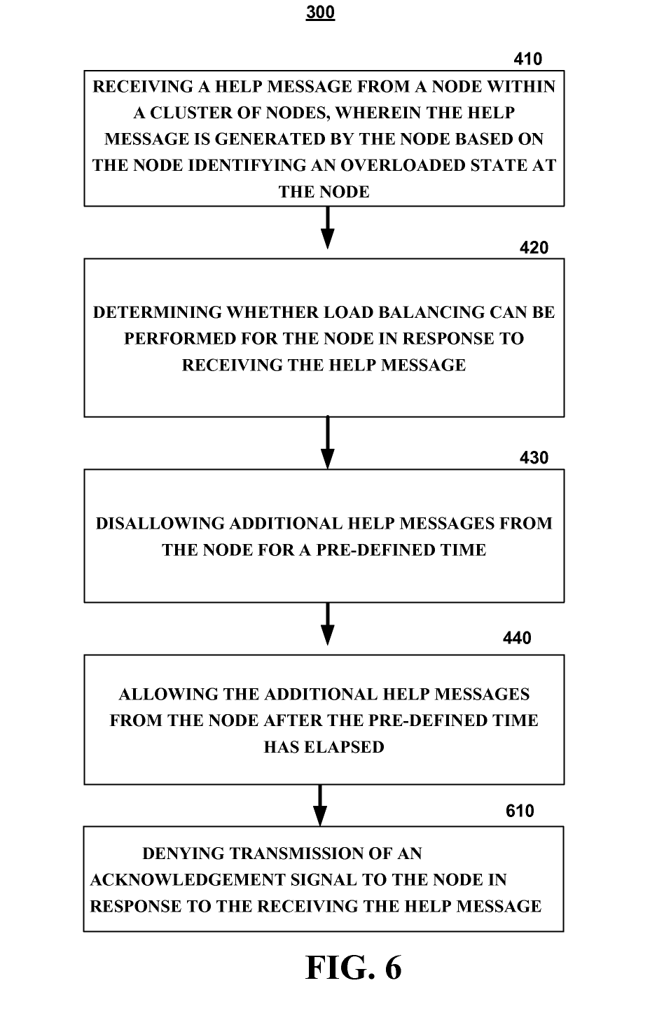

Turning now to FIG. 6, method 600 includes 410-440 of method 400 as described above. At 610, method 600 includes denying transmission of an acknowledgement signal to the node in response to the receiving the help message. As such, no acknowledgement signals are employed in the method.

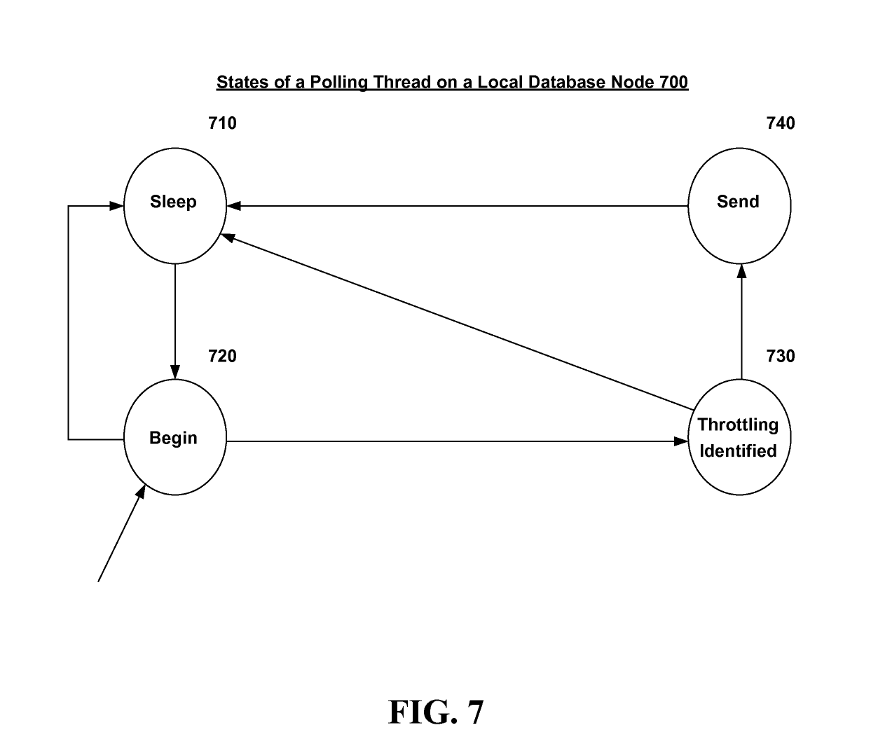

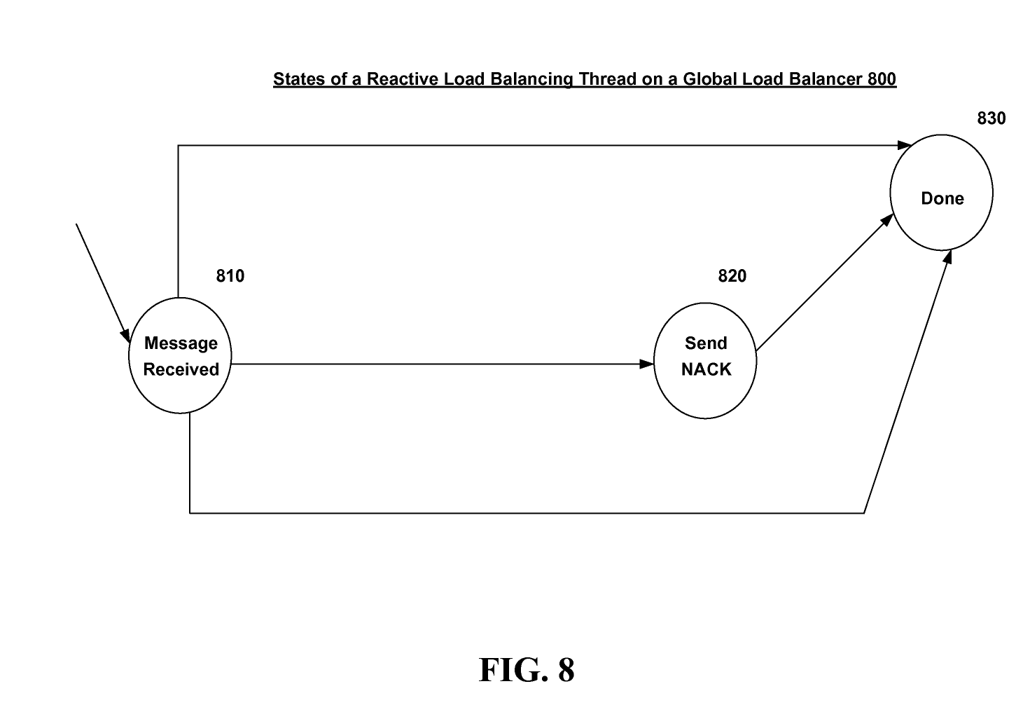

Turning to FIGS. 7 and 8, illustrated are two state machines illustrating states for the help message protocol. FIG. 7 is a block diagram illustrating states of a polling thread on a local database node. The purpose of the polling thread is for the LB Agent of the DN to respond to excessive throttling at the DN and to request help from the reactive load balancer. The polling thread responds to NACK messages from the MN and fills fields of the help message to the MN. The fields include information about load metrics at the DN, the transaction log size per partition at the node (to help the MN determine whether performing a swap and aborting all pending transactions is too expensive). As shown in FIG. 7, one state machine runs on the local DN to handle sending help messages to the central load balancer.

Turning first to FIG. 7, at 710, the DN is in the sleep state. At 720, the help message protocol begins. The state machine can oscillate between the sleep mode and the beginning of the protocol, as shown in FIG. 7. For example, the state machine can move back to the sleep state if the load balancing agent at the DN does not identify excessive throttling at the DN.

At 730, the DN moves into a state at which throttling is identified. At 740, if no NACK message has been recently received by the DN, the DN moves into a state at which a help message is sent from the DN to the central load balancer at 740. After sending the help message, the DN can move back into the sleep state at 710.

If the DN has recently received a NACK message and the NACK message hasn't expired, the DN moves back into the sleep state at 710.

The polling thread incorporates the poll interval (expressed in seconds), which identifies the amount of time between polling thread invocations. In some embodiments, this is 30 seconds. In some embodiments, this could also be a multiple of the period of time associated with engine throttling (e.g., 10 seconds) rather than a specific time in seconds.

The polling thread also incorporates a statistics window (expressed in seconds). The statistics window determines how far in the past to evaluate to determine the percentage of time that a request is being throttled by the DN. This value can be a multiple of the time interval between throttling runs (e.g., 10 seconds). However, the polling thread can accept any value (e.g., 300 seconds, or 5 minutes). In some embodiments, this could be value a count/number of throttling intervals instead of number of seconds.

The polling thread also incorporates a throttling time threshold (expressed as a ratio). If the percentage of time spent throttled in the statistics window is greater than the throttling time threshold, then the DN can request help from the global load balancer via the help message protocol described herein. In some embodiments, the throttling time threshold is 0.80, or 80%.

In some embodiments, if the ratio of throttling events is larger than throttling time threshold for the past statistics window, and if the reason for the throttling is purely due transient overloadedness, the polling thread will send out a help message. After sending out a help message, the polling thread then goes to sleep until it is scheduled to run again (as shown in FIG. 7). The polling thread does not wait for an ACK/NACK, because if the original help message was lost and if excessive throttling is still occurring, the next run of the polling thread will send another help message. As such, the protocol is designed without the load balancer sending ACK messages to acknowledge the receipt of a help message.

FIG. 8 is a block diagram illustrating states of a reactive load balancing thread on a global load balancer. As shown in FIG. 8, the other state machine runs on the central load balancer and handles help message processing. Now turning to FIG. 8, states of a reactive load balancing thread on a global load balancer are shown and described. At 810, the help message is received at the global load balancer. At 820, if the help message is to be dropped and not processed by the global load balancer, the global load balancer can move to state 820 at which the global load balancer sends a NACK message to the DN. Prior to sending the NACK message, the global load balancer sets the NACK timeout value to a pre-defined time. During such pre-defined time, the DN is disallowed, or squelched, from sending additional help messages.

If the help message from the sending DN is being processed, the global load balancer moves to state 830 at which the state of the global load balancer is on hold until processing of the help message and/or resource allocation for the DN is completed.

If the help message is not being processed, and the help message is not to be dropped, the global load balancer places the help message into a queue of pending requests and moves to state 830.

Numerous parameters can be configured at the load balancer to facilitate the processing herein. For example, a threshold can be set (e.g., 1 MB (1048576 bytes)) for a maximum log size of a log for a partition that can be relocated as part of reactive load balancing. As another example, a parameter can be set (e.g., 300 seconds) for the amount of time that a DN must wait before the DN can request a reactive load balancing allocation after the most recent allocation for the DN.

As another example, a parameter can be set (e.g., DN 300 seconds) for the amount of time that a DN must wait before the DN can request a reactive load balancing allocation after the most recent request yielded no solutions. This is to avoid excessive requests from the DN when no suitable allocation is on the horizon.

As another example, a parameter can be set (e.g., 3600 seconds) for how long the DN must wait before the DN can request a reactive load balancing allocation after the DN has reached the excessive help request count threshold.

As another example, a parameter can be set (e.g., 3600 seconds) for how the length of the window used to count the number of successful load balancing operations on a given DN.

As another example, a parameter can be set (e.g., 3) for how many successful load balancing operations in a time interval that are allowed before that DN node is blacklisted by the load balancer.

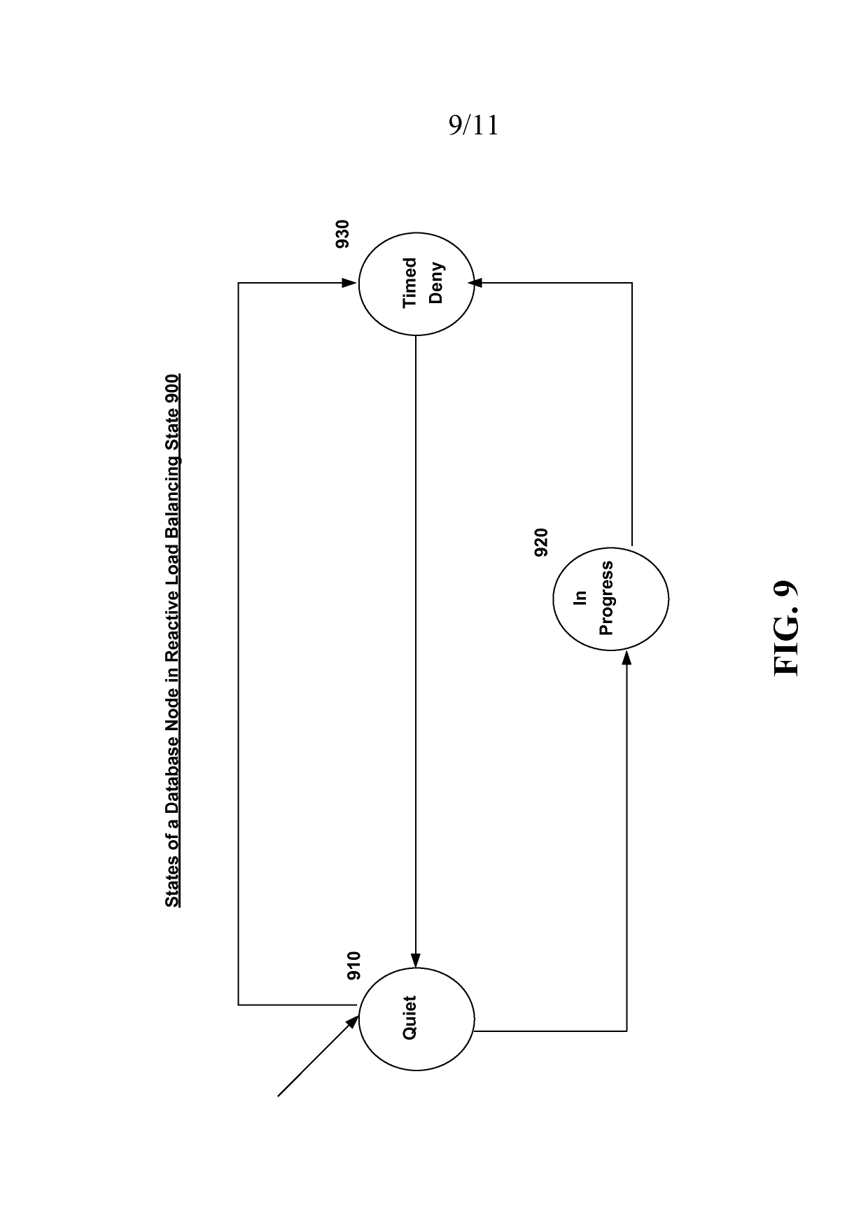

Turning now to FIG. 9, illustrated is a state machine for a DN reactive load balancing state. As shown, at 910, the DN is in the quiet state. In the quiet state, a help message has been received for processing at the central load balancer. From the quiet state, the DN can move to the TimedDeny state if the help message has been received by the central load balancer and dropped. The TimedDeny state is the state when any help messages received from the DN 202 will receive a NACK from the MN 204 until a pre-defined specified time.

At 920, the DN moves to the InProgress state if the help message received is passed to the queue at the central load balancer. The InProgress state is the state when a help message has been received, either is in filtered help message queue or is currently being processed by the MN 204.

Help messages that are not dropped upon receipt are forwarded to the reactive load balancer thread via a producer-consumer queue. If the queue is full, then the receive message thread will simply drop the help message. This is allowable, as the DN will then re-send the help message at the next polling interval if the DN still needs help.

In some embodiments, if a help message is received from a DN that is already in the InProgress state, the receive thread at the load balancer will attempt to find the previous message from that DN in the message queue and update the message to keep the messages in the queue up to date. If no message is found, then the second help message is discarded.

At 930, the DN moves to the TimedDeny state is the help message processed is denied (albeit for a pre-defined time). In the TimedDeny state, the DN can move to the quiet state at 910, if the help message has been received and the pre-defined time has elapsed.

In the embodiments described herein in FIGS. 1-9, and utilizing reference numerals from FIG. 1 for illustrative purposes, each DN 102 is responsible for detecting excessive throttling at the respective DN 102, and for notifying the load balancer on the MN 114 that excessive throttling is being applied at the DN 102. The MN 114 is then responsible for responding to the help request by attempting to reallocate resources to address the excessive throttling, followed by sending the resource allocation to the appropriate DNs 102 or by denying the request for help received from the DN 102 if no suitable resource allocation is identified by the MN 114.

Additionally, functionality can be distributed based on the excessive throttling detection being performed at the DN 102 while the MN 114 performs the heavy computation to determine resource allocation (e.g., determining how partition loads should be shifted).

While the embodiments described utilize centralized decision making for load balancing (e.g., a centralized load balancer performs the resource allocation), the decision making component could be distributed as opposed to centralized to improve scalability of the system, and reduce the likelihood of bottlenecks caused by a central decision maker. In embodiments wherein the decision making is distributed, load balancing then becomes decentralized.

In some embodiments, not all help messages received are actually processed by the reactive load balancer. Some help messages are dropped because the load balancing mechanism is currently busy with a reconfiguration, the node recently was granted a resource allocation, or the node was blacklisted for various reasons.

### Exemplary Networked and Distributed Environments

One of ordinary skill in the art can appreciate that the various embodiments of the distributed transaction management systems and methods described herein can be implemented in connection with any computer or other client or server device, which can be deployed as part of a computer network or in a distributed computing environment, and can be connected to any kind of data store where snapshots can be made. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the concurrency control mechanisms as described for various embodiments of the subject disclosure.

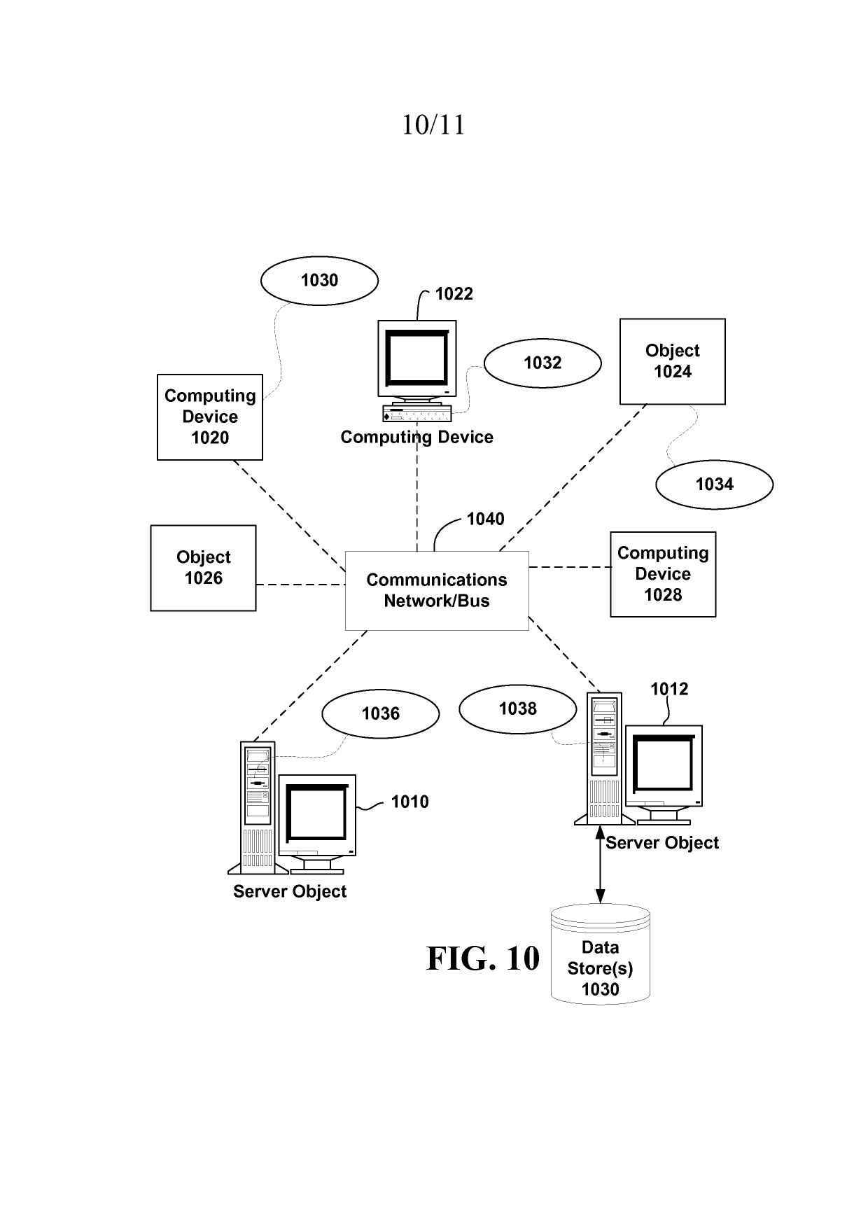

FIG. 10 provides a schematic diagram of an exemplary networked or distributed computing environment. The distributed computing environment comprises computing objects 1010, 1012, etc. and computing objects or devices 1020, 1022, 1024, 1026, 1028, etc., which may include programs, methods, data stores, programmable logic, etc., as represented by applications 1030, 1032, 1034, 1036, 1038. It can be appreciated that computing objects 1010, 1012, etc. and computing objects or devices 1020, 1022, 1024, 1026, 1028, etc. may comprise different devices, such as PDAs, audio/video devices, mobile phones, MP3 players, personal computers, laptops, etc.

Each computing object 1010, 1012, etc. and computing objects or devices 1020, 1022, 1024, 1026, 1028, etc. can communicate with one or more other computing objects 1010, 1012, etc. and computing objects or devices 1020, 1022, 1024, 1026, 1028, etc. by way of the communications network 1040, either directly or indirectly. Even though illustrated as a single element in FIG. 10, communications network 1040 may comprise other computing objects and computing devices that provide services to the system of FIG. 10, and/or may represent multiple interconnected networks, which are not shown. Each computing object 1010, 1012, etc. or computing object or device 1020, 1022, 1024, 1026, 1028, etc. can also contain an application, such as applications 1030, 1032, 1034, 1036, 1038, that might make use of an API, or other object, software, firmware and/or hardware, suitable for communication with or implementation of the concurrency control provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the serializable snapshot isolation systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 10, as a non-limiting example, computing objects or devices 1020, 1022, 1024, 1026, 1028, etc. can be thought of as clients and computing objects 1010, 1012, etc. can be thought of as servers where computing objects 1010, 1012, etc., acting as servers provide data services, such as receiving data from client computing objects or devices 1020, 1022, 1024, 1026, 1028, etc., storing of data, processing of data, transmitting data to client computing objects or devices 1020, 1022, 1024, 1026, 1028, etc., although any computer can be considered a client, a server, or both, depending on the circumstances. Any of these computing devices may be processing data, or requesting transaction services or tasks that may implicate the concurrency control techniques for snapshot isolation systems as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for performing read set validation or phantom checking can be provided standalone, or distributed across multiple computing devices or objects.

In a network environment in which the communications network 1040 or bus is the Internet, for example, the computing objects 1010, 1012, etc. can be Web servers with which other computing objects or devices 1020, 1022, 1024, 1026, 1028, etc. communicate via any of a number of known protocols, such as the hypertext transfer protocol (HTTP). Computing objects 1010, 1012, etc. acting as servers may also serve as clients, e.g., computing objects or devices 1020, 1022, 1024, 1026, 1028, etc., as may be characteristic of a distributed computing environment.

### Exemplary Computing Device

As mentioned, advantageously, the techniques described herein can be applied to any device where it is desirable to perform distributed transaction management. It should be understood, therefore, that handheld, portable and other computing devices and computing objects of all kinds are contemplated for use in connection with the various embodiments, i.e., anywhere that a device may wish to read or write transactions from or to a data store. Accordingly, the below general purpose remote computer described below in FIG. 10 is but one example of a computing device. Additionally, a database server can include one or more aspects of the below general purpose computer, such as concurrency control component or transaction manager, or other database management server components.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

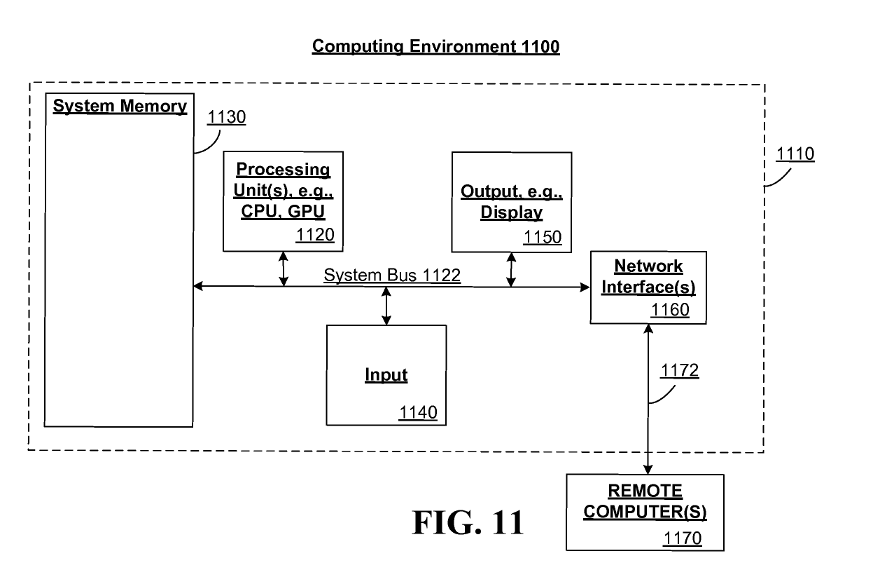

FIG. 11 thus illustrates an example of a suitable computing system environment 1100 in which one or aspects of the embodiments described herein can be implemented, although as made clear above, the computing system environment 1100 is only one example of a suitable computing environment and is not intended to suggest any limitation as to scope of use or functionality. Neither should the computing system environment 1100 be interpreted as having any dependency or requirement relating to any one or combination of components illustrated in the exemplary computing system environment 1100.

With reference to FIG. 11, an exemplary remote device for implementing one or more embodiments includes a general purpose computing device in the form of a computer 1110. Components of computer 1110 may include, but are not limited to, a processing unit 1120, a system memory 1130, and a system bus 1122 that couples various system components including the system memory to the processing unit 1120.

Computer 1110 typically includes a variety of computer readable media and can be any available media that can be accessed by computer 1110. The system memory 1130 may include computer storage media in the form of volatile and/or nonvolatile memory such as read only memory (ROM) and/or random access memory (RAM). By way of example, and not limitation, system memory 1130 may also include an operating system, application programs, other program modules, and program data.

A user can enter commands and information into the computer 1110 through input devices 1140. A monitor or other type of display device is also connected to the system bus 1122 via an interface, such as output interface 1150. In addition to a monitor, computers can also include other peripheral output devices such as speakers and a printer, which may be connected through output interface 1150.

The computer 1110 may operate in a networked or distributed environment using logical connections to one or more other remote computers, such as remote computer 1170. The remote computer 1170 may be a personal computer, a server, a router, a network PC, a peer device or other common network node, or any other remote media consumption or transmission device, and may include any or all of the elements described above relative to the computer 1110. The logical connections depicted in FIG. 11 include a network 1172, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to read and/or write transactions with high reliability and under potential conditions of high volume or high concurrency.

Also, there are multiple ways to implement the same or similar functionality, e.g., an appropriate API, tool kit, driver code, operating system, control, standalone or downloadable software object, etc. which enables applications and services to take advantage of the transaction concurrency control techniques. Thus, embodiments herein are contemplated from the standpoint of an API (or other software object), as well as from a software or hardware object that implements one or more aspects of the concurrency control including validation tests described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention should not be limited to any single embodiment, but rather should be construed in breadth, spirit and scope in accordance with the appended claims.

What is claimed is:

1. A reactive load balancing system, comprising:
a processor; and
a reactive load balancer configured to:
receive first feedback from a first database node of a set of nodes indicative of a load level of a dynamic load experienced by the first database node, wherein the first feedback is received at a first periodicity, wherein the first periodicity is substantially less than a second periodicity, the second periodicity being a periodicity at which statistical information is collected by a central load balancer for the set of nodes; and
reactively allocate resources from other ones of nodes in the set of nodes to the first database node based on the first feedback.

2. The reactive load balancing system of claim 1, wherein the reactive load balancer receives the first feedback as a compact message indicative of urgent help due to an overloaded load level.

3. The reactive load balancing system of claim 1, wherein the reactive load balancer is further configured to:
receive second feedback from a second database node of the set of nodes indicating that the second database node is under loaded.

4. The reactive load balancing system of claim 3, wherein the reactive load balancer is further configured to:
receive second feedback from a second database node of the set of nodes indicating that the second database node is no longer under loaded.

5. The reactive load balancing system of claim 1, wherein the set of nodes is a set of virtual machines.

6. The reactive load balancing system of claim 1, wherein the set of nodes is a set of relational database cache stores.

7. The reactive load balancing system of claim 1, wherein the set of nodes is a set of peer devices in a resource sharing arrangement.

8. A computer-implemented method, comprising:
load balancing a plurality of loads across a plurality of devices at a first granularity of time applicable to load balancing the plurality of devices;
detecting a help signal from a device of the plurality of devices indicating resource scarcity at the device, wherein the resource scarcity is applicable to a second granularity of time substantially smaller than the first granularity; and
reactively load balancing the device, including allocating resources from other devices, to satisfy the resource scarcity.

9. The computer-implemented method of claim 8, further comprising:
receiving, from a one of the other devices, information indicative of a cost for providing an available resource to the device; and
receiving use of the available resource based on acknowledging the cost.

10. The computer-implemented method of claim 9, wherein the receiving use of the available resource includes receiving use based on paying a price for the cost.

11. The computer-implemented method of claim 9, wherein the information is based on an auction model or a counteroffer the one of the other devices polling the plurality of devices.

12. A computer-implemented method, comprising:
receiving a help message from a node within a cluster of nodes, wherein the help message is generated by the node based on the node identifying an overloaded state at the node;
determining whether load balancing can be performed for the node in response to receiving the help message;
disallowing additional help messages from the node for a pre-defined time; and
allowing the additional help messages from the node after the pre-defined time has elapsed.

13. The computer-implemented method of claim 12, further comprising transmitting a negative acknowledgement signal to the node to squelch additional help messages from the node for the pre-defined time.

14. The computer-implemented method of claim 12, wherein the disallowing the additional help messages is performed in response to determining at least one of: load balancing cannot be performed for the node, load balancing was performed for the node during a first pre-defined past time interval, load balancing was attempted for the node during a second pre-defined past time interval and no load balancing could be performed or the help message has been received and processing has not been completed.

15. The computer-implemented method of claim 12, further comprising performing windowed time-based sampling to determine an accuracy of an identification of the overloaded state.

16. The computer-implemented method of claim 15, wherein the performing windowed time-based sampling comprises performing the windowed time-based sampling in response to the overloaded state being identified based on performance degradation identified at the node by the node.

17. The computer-implemented method of claim 16, wherein the performance degradation is identified if throttling back requests received at the node is identified by the node.

18. The computer-implemented method of claim 12, wherein the help message comprises statistics gathered by the node.

19. The computer-implemented method of claim 18, wherein the help message further comprises information indicating action desired by the node.

20. The computer-implemented method of claim 12, further comprising:
denying transmission of an acknowledgement signal to the node in response to the receiving the help message.
